(19) United States
(12) Patent Application Publication
(10) Pub. No.: US 2025/0285243 A1
(43) Pub. Date: Sep. 11, 2025

(54) IMAGE PROCESSING METHOD, ELECTRONIC DEVICE AND STORAGE MEDIUM

(71) Applicant: GUANGDONG OPPO MOBILE TELECOMMUNICATIONS CORP., LTD., Dongguan (CN)

(72) Inventor: Wei WEN, Dongguan (CN)

(21) Appl. No.: 19/070,144

(22) Filed: Mar. 4, 2025

(30) Foreign Application Priority Data
Mar. 5, 2024 (CN) 202410252871.6

(51) Int. Cl. G06T 5/77; G06T 3/40

(52) U.S. Cl. CPC G06T 5/77; G06T 3/40; G06T 2207/20132; G06T 2207/30168

(57) ABSTRACT

Provided are an image processing method, an electronic device and a storage medium. In the method, a to-be-inpainted image is obtained based on an original image, where an image size of the to-be-inpainted image is a target image size to which the original image is desired to be adjusted, the to-be-inpainted image includes a first image area corresponding to the original image and a second image area other than the first image area, and the second image area is an area for which image inpainting is to be performed. The second image area in the to-be-inpainted image is inpainted with a pre-trained image inpainting model, and an intermediate image is obtained. The second image area in the intermediate image is inpainted with a pre-trained large language model, and a first target image is obtained.

### CROSS-REFERENCING OF RELEVANT APPLICATIONS

This application claims priority to Chinese patent application No. CN 202410252871.6, filed on Mar. 5, 2024, which is herein incorporated by reference in its entirety.

### TECHNICAL FIELD

The present disclosure relates to the technical field of electronic devices, and particularly to an image processing method, an electronic device and a storage medium.

### BACKGROUND

Images are the basis of human vision, and they reflect natural scenery objectively. Images facilitate humans to understand the world and themselves. With the development of network technology, people mainly obtain images through Internet. People may browse or query different images through web pages or websites. Usually, for a same image, different sizes may be required when it is displayed in different scenes. Thus, it is usually necessary to adjust the size of the image to match different display scenes. However, the image size adjustment methods in the related art have low efficiency.

### SUMMARY

The present disclosure proposes an image processing method, an electronic device and a storage medium.

In a first aspect, embodiments of the present disclosure provide an image processing method. In the method, a to-be-inpainted image is obtained based on an original image, where an image size of the to-be-inpainted image is a target image size to which the original image is desired to be adjusted, the to-be-inpainted image includes a first image area corresponding to the original image and a second image area other than the first image area, and the second image area is an area for which image inpainting is to be performed. The second image area in the to-be-inpainted image is inpainted by using a pre-trained image inpainting model, and an intermediate image in which the second image area has been inpainted by the image inpainting model is obtained. The second image area in the intermediate image is inpainted by using a pre-trained large language model, and a first target image in which the second image area has been inpainted by the large language model is obtained.

In a second aspect, the embodiments of the present disclosure provide an electronic device. The electronic device includes one or more processors, a memory, and one or more programs. The one or more programs are stored in the memory and configured to be executed by the one or more processors, and the one or more programs are configured to execute the image processing method provided in the first aspect above.

In a third aspect, the embodiments of the present disclosure provide a non-transitory computer-readable storage medium storing program codes therein. The program codes are invokable by a processor to execute the image processing method provided in the first aspect above.

### BRIEF DESCRIPTION OF THE DRAWINGS

In order to more clearly illustrate the technical solutions in the embodiments of the present disclosure, drawings required for use in the description of the embodiments will be briefly introduced below. Apparently, the drawings described below are only some embodiments of the present disclosure. For those skilled in the art, other drawings can be obtained based on these drawings without creative work.

FIG. 1 is a schematic flow chart of an image processing method according to an embodiment of the present disclosure.

FIG. 2 is a schematic diagram illustrating the effect of the image processing method provided in the embodiment of the present disclosure.

FIG. 3 is a schematic flow chart of an image processing method according to another embodiment of the present disclosure.

FIG. 4 is a schematic diagram of an interface provided in an embodiment of the present disclosure.

FIG. 5 is a schematic flow chart of an image processing method according to yet another embodiment of the present disclosure.

FIG. 6 is a schematic diagram of an interface provided in an embodiment of the present disclosure.

FIG. 7 is a schematic diagram of an interface provided in an embodiment of the present disclosure.

FIG. 8 is a schematic flow chart of an image processing method according to yet a further embodiment of the present disclosure.

FIG. 9 is a block diagram of an image processing apparatus according to an embodiment of the present disclosure.

FIG. 10 is a block diagram of an electronic device according to an embodiment of the present disclosure, which electronic device is used to execute the image processing method of the embodiments of the present disclosure.

FIG. 11 illustrates a storage unit according to an embodiment of the present disclosure, which storage unit is used to store or carry program codes for implementing the image processing method of the embodiments of the present disclosure.

### DETAILED DESCRIPTION OF PREFERRED EMBODIMENTS

In order to enable those skilled in the art to better understand the solutions of the present disclosure, the technical solutions in the embodiments of the present disclosure will be clearly and comprehensively described below in conjunction with the drawings in the embodiments of the present disclosure.

In different image display scenarios, different image sizes may be required. For example, in advertising, it is usually necessary to deliver a same creative image to ad slots of different sizes. Therefore, there is a need to design the same creative image to have different sizes, so as to match ad slots of different sizes.

In term of adjusting the image size of an original image, an image of a desired image size may usually be obtained by scaling, cropping or performing other processing on the original image. However, in some image size adjustment scenarios, there may be a blank area after the image size is adjusted. For example, in a case where an original image with an aspect ratio of 3:2 needs to be adjusted to have an image size with an aspect ratio of 16:9, even if the original image is upscaled proportionally, the image size with an aspect ratio of 16:9 cannot be reached, and there would be a blank area relative to the required image size with the aspect ratio of 16:9. In the related art, the blank area may usually be filled, for example, through manual image padding of the user by himself/herself, or with the help of professionals. This would however take a lot of time and incur a high cost. Also, if the user performs the image padding by himself/herself, the blank area would generally be filled in a simple way, have a clear boundary, look unnatural and so on, which results in low image quality.

In view of the above, the inventor proposes an image processing method and apparatus, an electronic device and a storage medium provided in the embodiments of the present disclosure. With such solutions, in adjusting the image size of an original image, an area other than the original image in a to-be-inpainted image (that is obtained based on the original image) may be inpainted, which eliminates the need for the user to perform padding or expansion on the basis of the original image by himself/herself, thereby improving the efficiency of adjusting the image size. In addition, when performing image inpainting, a pre-trained image inpainting model is first used for the inpainting, and then a large language model is used for further inpainting, which improves the image quality. In embodiments of the disclosure, image inpainting is an operation used to restore/correct a missing or damaged part in an image.

The image processing method provided in the embodiments of the present disclosure is described in detail below with reference to the accompanying drawings.

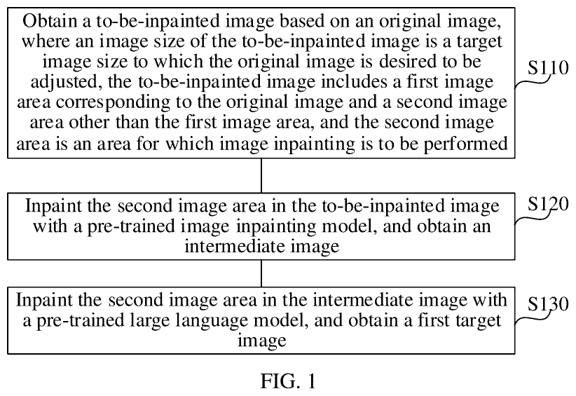

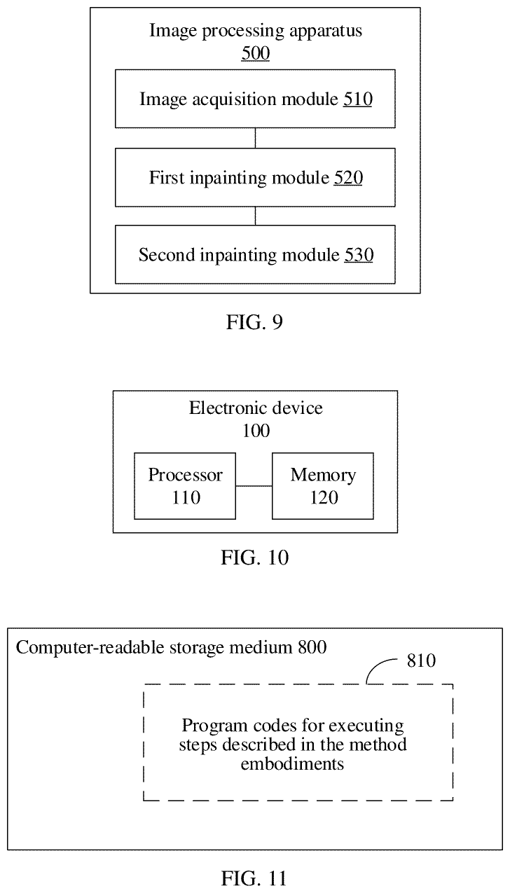

As illustrated in FIG. 1, a schematic flow chart of an image processing method provided in an embodiment of the present disclosure is shown. In a specific implementation, the image processing method is applied to an image processing apparatus 500 as illustrated in FIG. 9 and an electronic device 100 (see FIG. 10) equipped with the image processing apparatus 500. The specific process of this embodiment will be described below by taking an electronic device as an example. Of course, it is understandable that the electronic device used in the embodiments may be a smart phone, a tablet computer, a laptop computer, an e-book, etc., which is not limited here. The following describes in detail the process shown in FIG. 1. The image processing method may specifically include operations S110 to S130 as follows.

At S110, a to-be-inpainted image is obtained based on an original image, where an image size of the to-be-inpainted image is a target image size to which the original image is desired to be adjusted, the to-be-inpainted image includes a first image area corresponding to the original image and a second image area other than the first image area, and the second image area is an area for which image inpainting is to be performed.

In the embodiments of the present disclosure, when the image size of the original image is adjusted, there may be a blank area in an image of the target image size that is obtained from the original image. Image inpainting may be performed on the blank area, so as to obtain an image of the target image size required by the user. The electronic device may obtain a to-be-inpainted image based on the original image. In addition to the first image area corresponding to the original image, the to-be-inpainted image also includes an area which is apart from the first image area and for which the image inpainting is to be performed (i.e., a second image area). The image size of the to-be-inpainted image is equal to the target image size to which the original image is desired to be adjusted. After the to-be-inpainted second image area in the to-be-inpainted image is inpainted subsequently, the final image of the target image size (which is obtained after the image size of the original image is adjusted) may be obtained.

In some implementations, the electronic device may acquire the original image, and determine the to-be-inpainted image of the target image size based on the original image.

In a possible implementation, the electronic device may capture an image of a real scene, and obtain a captured original image. The electronic device may be a mobile terminal equipped with a camera, such as a smart phone, a tablet computer, and a smart watch. The electronic device may capture images through a front camera or a rear camera to obtain the original image mentioned above. For example, the electronic device may capture an image through the rear camera, and use the captured image as the original image.

In a possible implementation, the electronic device may acquire the original image locally, that is, the electronic device may acquire the original image from a locally stored file. For example, when the electronic device is a mobile terminal, the original image may be acquired from a photo album; that is, the electronic device captures an image through its camera and stores it in a local photo album in advance, or downloads an image from the network and stores it in the local photo album in advance, and then reads the original image from the photo album when there is a need to perform field of view completion for the image.

In a possible implementation, when the electronic device is a mobile terminal or a computer, the original image may also be downloaded from the network. For example, the electronic device may download a required original image from a corresponding server through a wireless network, a data network, etc. When the electronic device is a head-mounted display device, it may also receive an image transmitted by other devices and use it as the original image.

Of course, the specific manner in which the electronic device acquires the original image may not be limited herein.

In a possible implementation, regarding determining the to-be-inpainted image based on the original image, the to-be-inpainted image may be determined according to the required position, size and the like of the original image in an image of the target image size. Based on the required position, size and the like of the original image in the image of the target image size, scaling and/or cropping may be performed on the original image, and then a blank area(s) may be augmented/supplemented in the periphery the original image, to obtain the to-be-inpainted image. The augmented blank area is the second image area for which the image inpainting is to be performed.

At S120, the second image area in the to-be-inpainted image is inpainted by using a pre-trained image inpainting model, and an intermediate image is obtained therefrom.

In the embodiments of the present disclosure, after acquiring the to-be-inpainted image, the electronic device may use the pre-trained image inpainting model to inpaint the second image area in the to-be-inpainted image, and the intermediate image in which the second image area is preliminarily inpainted is thus obtained.

In some embodiments, the image inpainting model may be a Large Mask Inpainting (LaMa) model. In inpainting the second image area in the to-be-inpainted image with the LaMa model, an inpainting mask image corresponding to the to-be-inpainted image may be obtained; then, the to-be-inpainted image and the inpainting mask image are input into the pre-trained image inpainting model, and the intermediate image in which the second image area has been inpainted by the image inpainting model is obtained. The inpainting mask image is a mask image corresponding to the second image area for which the image inpainting is to be performed. In the field of image processing, the mask refers to using a selected image, graphic or object to block a corresponding image area, so as to control the image processing area or processed object.

In the above implementations, the LaMa model may enable arbitrary deletion and replacement of various target objects in the image. After the inpainting mask image and the to-be-inpainted image are input into the LaMa model, the LaMa model inputs a composite image, which is obtained by overlaying the inpainting mask image onto the to-be-inpainted image, into an inpainting network, and the inpainting network downsamples the composite image to a preset image size which is smaller than the target image size. Then, the downsampled composite image passes through a Fast Fourier Convolution (FFC) residual block, and a result output by the FFC residual block is upsampled to be restored to the target image size, thereby obtaining the intermediate image. The preset image size may be 256*256, 512*512, etc., which may not be limited here. In the composite image, after the inpainting mask image is overlaid on the to-be-inpainted image, the second image area in the masked to-be-inpainted image is masked, and the masked area in the to-be-inpainted image may be determined by the inpainting network as the area that needs to be inpainted.

In the FFC residual block, operations are performed on the input image in two branches. A Local branch uses regular convolution, and a Global branch uses Real FFT for global context attention. In the Global branch, operations of Real FFT2d and Inverse Real FFT2d are performed to achieve image reconstruction. Finally, the operation results of the two branches are merged to form the output of the FFC residual block.

During the training process of the LaMa model, in calculating a loss value, a total loss of the LaMa model may include the loss of a Generative Adversarial Network (GAN), a generator perceptual loss, a discriminator perceptual loss, and a discriminator gradient penalty, where the generator perceptual loss may be a high receptive field perceptual loss (HRFPL). Exemplarily, the total loss of the LaMa model may be calculated using the following formula:

$${L}_{final} = {kL}_{Adv} + α {L}_{HRFPL} + β {L}_{DiscPL} + γ {R}_{1} ,$$

where L_{final} represents the total loss of the LaMa model, L_{Adv} represents the generator perceptual loss, L_{HRFPL} represents the high receptive field perceptual loss, L_{DiscPL} represents the discriminator perceptual loss, R₁ represents the discriminator gradient penalty, and κ, α, β and γ are weights of L_{Adv}, L_{HRFPL}, L_{DiscPL} and R₁ respectively. HRFPL calculates the feature similarity between the input image and the generated image through a pre-trained basic network. Specifically, the HRF constructed using dilated convolution or Fourier convolution is used for calculation pixel by pixel, and then a two-stage mean operation is performed, that is, an intra-layer mean is calculated first and then an inter-layer mean is calculated.

Of course, in the embodiments of the present disclosure, the specific model of the image inpainting model used to perform preliminary inpainting on the second image area in the to-be-inpainted image may not be limited. For example, the image inpainting model may also be a CM-GAN model, an SRGAN model, an ESRGAN model, etc.

At S130, the second image area in the intermediate image is inpainted by using a pre-trained large language model, and a first target image is obtained therefrom.

In the embodiments of the present disclosure, after the intermediate image in which the second image area in the to-be-inpainted image has been inpainted by the image inpainting model is obtained, the second image area in the intermediate image may be further inpainted by the large language model, so as to obtain the final first target image. That is, in adjusting the original image to have the target image size, the to-be-inpainted area (which needs to be padded or augmented), other than the area where the original image is located, is inpainted, so as to obtain an image of the target image size, which eliminates the need for the user to perform padding or expansion on the basis of the original image by himself/herself, thereby improving the efficiency of adjusting the image size. Inpainting the second image area in the intermediate image by using the large language model may be understood as performing redrawing and generating operations on the second image area in the intermediate image.

In some embodiments, when the pre-trained large language model performs inpainting on the second image area in the intermediate image, an input target prompt word may be acquired, and the target prompt word represents information on target inpainting of the second image area (i.e., information on desired inpainting of the second image area). Then, the target prompt word and the intermediate image are input into the pre-trained large language model, and the first target image in which the second image area has been inpainted by the large language model is obtained. The target prompt word may include content description information of the to-be-inpainted image, content description information of the second image area, and the like. It is understandable that, since the large language model has good language ability, this method enables the user to use natural language prompts to guide the large language model, to obtain an image meeting the user's requirements.

In a possible implementation, the large language model may be a stable diffusion (SD) model. The diffusion model is a progressive denoising network, which gradually restores the image from the noisy image, and achieves an effect of gradually generating the image from the random noise. The SD model is a latent-based diffusion model, and the principle thereof is to perform forward diffusion and noise addition on an image to obtain a normally distributed vector z, fuse text features and then perform back-diffusion to obtain the image. And in the inference stage, the forward diffusion and denoising process is abandoned, and the text features and the random normally distributed vector are directly back-diffused to obtain an image corresponding to the text features.

Optionally, the SD model may be a Stable Diffusion XL (SDXL) model, which is an improved SD model. Compared with the common SD model, the UNet backbone network of the SDXL model is enlarged by 6 times; two simple and effective additional conditions are introduced without any additional supervision; and a diffusion-based refinement model is introduced to improve the visual quality of the image by denoising the latent space generated by SDXL.

In some scenarios, if the image processing method provided in the embodiments of the present disclosure is applied to scenarios of advertisements and game materials, that is, for image size adjustment of creative images in scenarios of advertisements and game materials, the SDXL model may be fine-tuned with a low-rank adaptation (LoRA) model, the SDXL model and LoRA model training scripts may be run, and TensorBoard may be used to monitor the model training, etc.

In a possible implementation, after obtaining the first target image, the electronic device may display the first target image. For example, the electronic device may display the first target image in a preview interface configured to present the image size adjustment result. The electronic device may detect an operation performed on the preview interface. If a re-input target prompt word and a regeneration operation are detected, in response to the regeneration operation, the electronic device may use the large language model to re-inpaint, according to the re-input target prompt word, the second image area in the intermediate image, thereby obtaining a new image. Therefore, after the first target image is obtained, it may be determined whether to continue to perform refined inpainting on the image according to user needs, so that the final image has rich details and excellent quality.

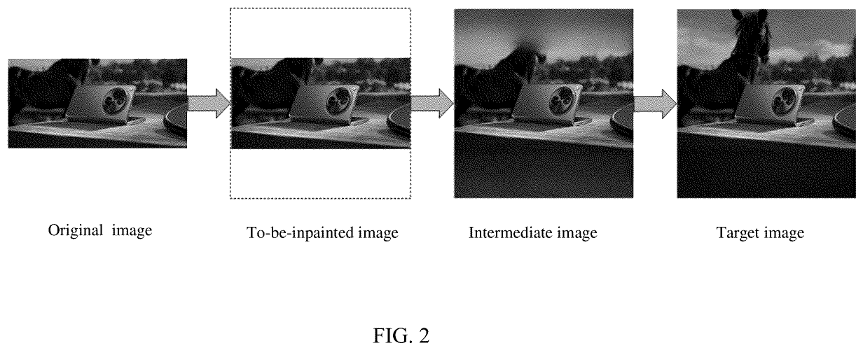

Exemplarily, as illustrated in FIG. 2, a schematic diagram illustrating the effect of the image processing method provided by the embodiment of the present disclosure is shown. After the to-be-inpainted image of the target image size is obtained based on the original image, the blank area in the to-be-inpainted image may be inpainted by the pre-trained image inpainting model, to obtain the intermediate image. Then, the intermediate image is further inpainted by a stable diffusion model, to obtain the target image, thereby completing the process of adjusting the image size of the original image. As can be seen, in the process of adjusting the image size of the original image, when it is necessary to augment/expand the image area based on the original image, the augmented/expanded area may be made more realistic and natural, which improves the image quality.

With the image processing method provided in the embodiment of the present disclosure, in adjusting the image size of the original image, the area other than the original image in the to-be-inpainted image (which is obtained based on the original image) may be inpainted, which eliminates the need for the user to perform padding or expansion on the basis of the original image by himself/herself, thereby improving the efficiency of adjusting the image size. In addition, when performing the image inpainting, the pre-trained image inpainting model is first used for the inpainting, and then the large language model is used for further inpainting, which improves the image quality.

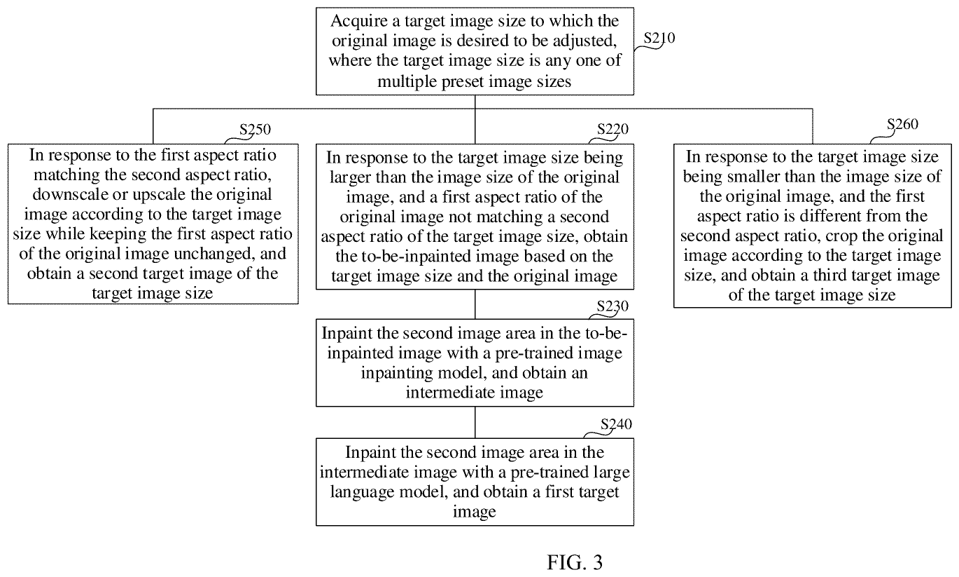

As illustrated in FIG. 3, a flow chart of an image processing method provided in another embodiment of the present disclosure is shown. The image processing method is applied to the above electronic device. The following describes in detail the process shown in FIG. 3. The image processing method may specifically include operations S210 to S260 as follows.

At S210, a target image size to which the original image is desired to be adjusted is acquired, where the target image size is any one of multiple preset image sizes.

In the embodiment of the present disclosure, the target image size to which the original image is desired to be adjusted may be a preset image size, and the preset image size may be a preset selectable image size.

In some embodiments, when acquiring the target image size to which the original image is desired to be adjusted, the electronic device may display an image editing interface, where the image editing interface includes selection controls corresponding to different preset image sizes respectively. The electronic device may detect an operation performed on the image editing interface. When a trigger operation, such as a click operation or a press operation, for a target selection control is detected, in response to the trigger operation, the electronic device may determine the preset image size corresponding to the target selection control as the target image size to which the original image is desired to be adjusted.

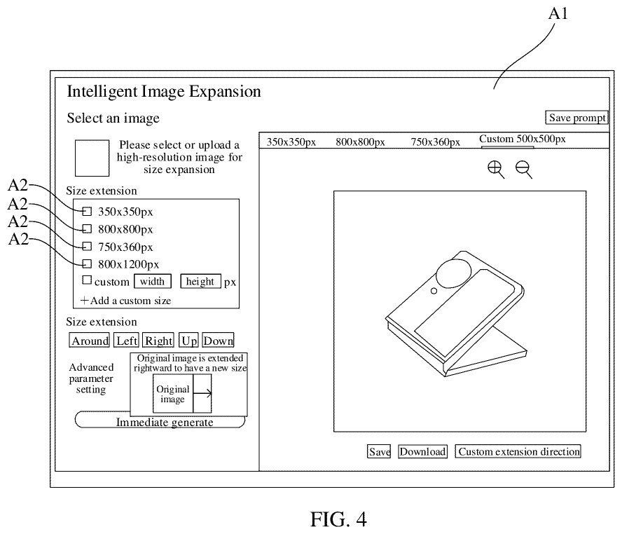

Exemplarily, as illustrated in FIG. 4, the electronic device may display an image editing interface A1, and the image editing interface A1 includes selection controls A2 respectively corresponding to preset image sizes such as 350×350 px, 800×800 px, 750×360 px, and 800×1200 px. Based on the detected operation performed for a corresponding selection control A2, the electronic device may obtain the target image size to which the original image is desired to be adjusted.

At S220, in response to the target image size being larger than the image size of the original image, and a first aspect ratio of the original image not matching a second aspect ratio of the target image size, the to-be-inpainted image is obtained based on the target image size and the original image.

The first aspect ratio is a ratio of the length to the width of the original image, and the second aspect ratio is a ratio of the length to the width of the target image size. The to-be-inpainted image includes a first image area corresponding to the original image and a second image area other than the first image area, and the second image area is an area for which image inpainting is to be performed.

In the embodiments of the present disclosure, in the case where the target image size to which the original image is desired to be adjusted is a preset image size, it may be determined whether the target image size is larger than the image size of the original image, and whether the first aspect ratio of the original image matches the second aspect ratio of the target image size. According to the determination results, if the target image size is larger than the image size of the original image, and the first aspect ratio does not match the second aspect ratio, it means that the target image size cannot be obtained by simply upscaling the original image proportionally (that is, upscaling the original image while keeping the aspect ratio thereof unchanged), and the to-be-inpainted image may be obtained based on the target image size and the original image, so that a target image of the required target image size is subsequently obtained after the second image area in the to-be-inpainted image is inpainted using the image processing method provided in the embodiments of the present disclosure. It is understandable that, in the case where the target image size is larger than the image size of the original image, it means that the image size of the original image needs to be enlarged to reach the target image size; however, because the first aspect ratio of the original image does not match the second aspect ratio of the target image size, it is impossible to achieve the target image size simply through proportional upscaling. In this case, the to-be-inpainted image of the target image size may be determined, and the second image area may be inpainted subsequently, to obtain the image required by the user.

In the above implementation, the first aspect ratio of the original image matching the second aspect ratio of the target image size may mean that, the first aspect ratio is equal to the second aspect ratio, or an absolute value of the difference between the first aspect ratio and the second aspect ratio is less than a target threshold, for example, the absolute value of the difference between the first aspect ratio and the second aspect ratio is less than 0.05, 0.02, etc.

In some embodiments, in the case where the target image size to which the original image is desired to be adjusted is larger than the image size of the original image, and the first aspect ratio of the original image does not match the second aspect ratio of the target image size, the to-be-inpainted image may be generated based on the original image and the target image size with the original image as a center, where the second image area in the to-be-inpainted image is a blank area. That is, the blank area may be augmented in the periphery of the original image according to the target image size to be adjusted to, so as to obtain the to-be-inpainted image of the target image size, where the augmented blank area is the second image area that needs to be inpainted later.

In some embodiments, in the case where the target image size to which the original image is desired to be adjusted is larger than the image size of the original image, and the first aspect ratio of the original image does not match the second aspect ratio of the target image size, the original image may be gradually upscaled while keeping the first aspect ratio of the original image unchanged, until an absolute value of the difference between the length of the original image and the length of the target image size is less than a preset length, or an absolute value of the difference between the width of the original image and the width of the target image size is less than a preset width. Then, the to-be-inpainted image may be generated based on the current upscaled original image and the target image size, with the current upscaled original image as a center. That is, according to the target image size to be adjusted to, a blank area may be augmented in the periphery of the current scaled original image, to obtain the to-be-inpainted image of the target image size, where the augmented blank area is the second image area that needs to be inpainted later.

At S230, the second image area in the to-be-inpainted image is inpainted by using a pre-trained image inpainting model, and an intermediate image is obtained therefrom.

At S240, the second image area in the intermediate image is inpainted by using a pre-trained large language model, and a first target image is obtained therefrom.

In the embodiment of the present disclosure, for operations S230 and S240, reference may be made to the contents of the aforementioned embodiment, which will not be repeated here.

At S250, in response to the first aspect ratio matching the second aspect ratio, the original image is downscaled or upscaled according to the target image size while keeping the first aspect ratio of the original image unchanged, and a second target image of the target image size is obtained therefrom.

In the embodiments of the present disclosure, based on the determination result of determining whether the first aspect ratio of the original image matches the second aspect ratio of the target image size, if the first aspect ratio matches the second aspect ratio, the original image may be downscaled or upscaled according to the target image size while keeping the first aspect ratio of the original image unchanged, thereby obtaining a second target image of the target image size. That is, the second target image of the required target image size is obtained by proportionally downscaling or upscaling the original image.

In downscaling or upscaling the original image according to the target image size while keeping the first aspect ratio of the original image unchanged, if the target image size is larger than the image size of the original image, the original image may be upscaled according to the target image size while keeping the first aspect ratio of the original image unchanged, thereby obtaining the second target image of the required target image size; and if the target image size is smaller than the image size of the original image, the original image may be downscaled according to the target image size while keeping the first aspect ratio of the original image unchanged, thereby obtaining the second target image of the required target image size.

At S260, in response to the target image size being smaller than the image size of the original image, and the first aspect ratio is different from the second aspect ratio, the original image is cropped according to the target image size, and a third target image of the target image size is obtained therefrom.

In the embodiments of the present disclosure, based on the determination results of determining whether the target image size is larger than the image size of the original image and determining whether the first aspect ratio of the original image matches the second aspect ratio of the target image size, if the target image size is smaller than the image size of the original image, and the first aspect ratio is different from the second aspect ratio, it means that the target image size cannot be reached simply by proportionally downscaling the original image (i.e., downscaling the original image while keeping the aspect ratio thereof unchanged). In this case, the original image may be cropped according to the target image size, to obtain the third target image of the target image size.

In some embodiments, in cropping the original image according to the target image size, a target image area of the target image size may be determined based on a center position of the original image, and then the remaining areas of the original image other than the target image area are cropped out. In other words, the target image area of the target image size that needs to be retained is determined based on the center position of the original image, and other image areas are cropped out.

In some embodiments, in cropping the original image according to the target image size, the original image may be gradually downscaled while keeping the first aspect ratio of the original image unchanged, until the absolute value of the difference between the length of the original image and the length of the target image size is less than a preset length, or the absolute value of the difference between the width of the original image and the width of the target image size is less than a preset width. Then, the target image area of the target image size may be determined based on the center position of the current downscaled original image, and then the remaining areas other than the target image area in the current original image are cropped out. That is, the target image area of the target image size that needs to be retained is determined based on the center position of the current downscaled original image, and other image areas are cropped out.

In the image processing method provided by the embodiment of the present disclosure, in the case where the target image size to which the original image is desired to be adjusted to is a preset image size, if the target image size is larger than the image size of the original image, and the first aspect ratio of the original image does not match the second aspect ratio of the target image size, the to-be-inpainted image may be determined based on the target image size and the original image, and the area of the to-be-inpainted image other than an area where the original image is located is inpainted, which eliminates the need for the user to perform padding or expansion on the basis of the original image by himself/herself, thereby improving the efficiency of adjusting the image size. In addition, when performing the image inpainting, the pre-trained image inpainting model is first used for the inpainting, and then the large language model is used for further inpainting, which improves the image quality. If the target image size is smaller than the image size of the original image, and the first aspect ratio does not match the second aspect ratio, the original image may be cropped to obtain an image of the required target image size. If the first aspect ratio matches the second aspect ratio, the original image may be downscaled or upscaled while keeping the aspect ratio of the original image unchanged to obtain an image of the required target image size. As such, the image size can be efficiently adjusted.

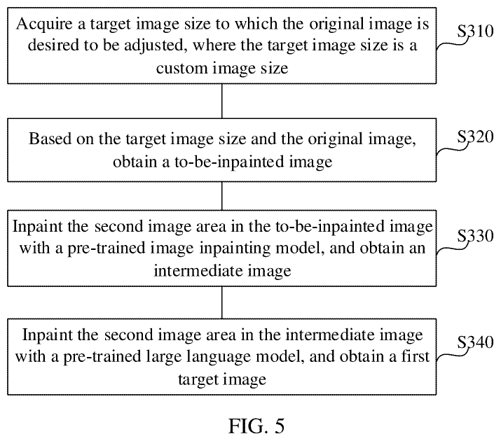

As illustrated in FIG. 5, a flowchart of an image processing method provided by yet another embodiment of the present disclosure is shown. The image processing method is applied to the above electronic device. The following describes in detail the process shown in FIG. 5. The image processing method may specifically include operations S310 to S340 as follows.

At S310, a target image size to which the original image is desired to be adjusted is acquired, where the target image size is a custom image size.

In the embodiments of the present disclosure, the target image size to which the original image is desired to be adjusted may be a custom image size, and the custom image size may be an image size defined based on a user operation.

In some embodiments, when acquiring the target image size to which the original image is desired to be adjusted, the electronic device may display a preview interface including a preview area, and the preview area includes the first image area corresponding to the original image. The electronic device may detect an operation performed on the preview area. When an adjustment operation performed on the preview area is detected, the position of at least one edge of the preview area relative to the edge of the first image area may be adjusted, that is, the size of the preview area is changed while keeping the size of the first image area unchanged. When a confirmation operation performed on the preview area is detected, the current size of the preview area may be obtained as the target image size to which the original image is desired to be adjusted. That is, based on the original image, the size may be expanded in the upward direction, downward direction, leftward direction and rightward direction, and the target image size may be determined based on the expansion(s); as such, the size may be expanded in the direction required by the user based on the original image.

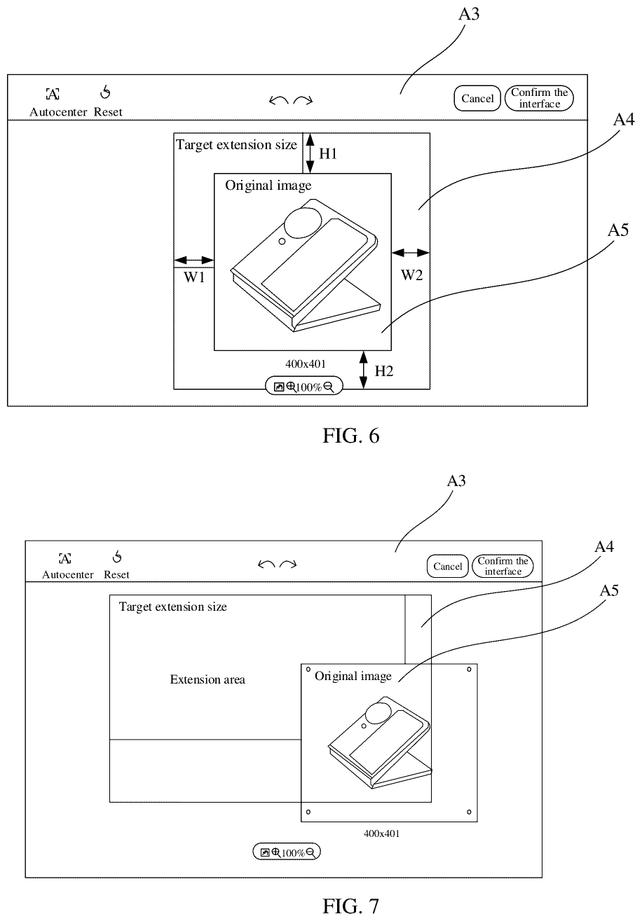

Exemplarily, as illustrated in FIG. 6, the electronic device may display a preview interface A3, the preview interface A3 includes a preview area A4, and the preview area A4 includes a first image area A5 corresponding to the original image. According to the user's adjustment operation for the preview area, the electronic device may expand the size of the preview area in different directions based on the original image.

At S320, based on the target image size and the original image, a to-be-inpainted image is obtained.

The to-be-inpainted image includes a first image area corresponding to the original image and a second image area other than the first image area, and the second image area is an area for which image inpainting is to be performed.

In the embodiments of the present disclosure, in the case where the target image size to which the original image is desired to be adjusted is a custom image size, the to-be-inpainted image may be obtained based on the target image size and the original image, so that a target image of the required target image size is subsequently obtained after the second image area in the to-be-inpainted image is inpainted using the image processing method provided in the embodiments of the present disclosure.

In some embodiments, in the case where the target image size to which the original image is desired to be adjusted is a custom image size, in acquiring the to-be-inpainted image based on the target image size and the original image, a preview interface may be displayed based on the target image size, the preview interface includes a preview area, the size of the preview area is equal to the target image size, and the preview area includes the first image area. In response to a further adjustment operation performed on the first image area, the position of the first image area in the preview area is adjusted, and/or the size of the first image area is adjusted. In response to a further confirmation operation performed on the preview area, the to-be-inpainted image is generated based on the preview area. In generating the to-be-inpainted image based on the preview area, the to-be-inpainted image may be generated based on the current position of the first image area where the original image is located in the preview area and the current size of the original image. The remaining area in the to-be-inpainted image except the first image area where the original image is located is a blank area. The position of the first image area in the generated to-be-inpainted image matches the position of the first image area in the preview area, and the size of the first image area in the generated to-be-inpainted image matches the size of the first image area in the preview area.

Exemplarily, as illustrated in FIG. 7, the electronic device may display a preview interface A3, the preview interface A3 includes a preview area A4, and the preview area A4 includes a first image area A5 corresponding to the original image. The electronic device may adjust at least one of the position and size of the first image area according to the user's adjustment operation performed on the first image area, and then generate a to-be-inpainted image according to the current preview area, so that the position and size of the first image area corresponding to the original image in the to-be-inpainted image can meet the user's requirements.

At S330, the second image area in the to-be-inpainted image is inpainted by using a pre-trained image inpainting model, and an intermediate image is obtained therefrom.

At S340, the second image area in the intermediate image is inpainted by using a pre-trained large language model, and a first target image is obtained therefrom.

In the embodiment of the present disclosure, for operations S330 and S340, reference may be made to the contents of the aforementioned embodiment, which will not be repeated here.

With the image processing method provided by the embodiment of the present disclosure, in adjusting the image size of the original image, the area other than the original image in the to-be-inpainted image (which is obtained based on the original image) is inpainted, which eliminates the need for the user to perform padding or expansion on the basis of the original image by himself/herself, thereby improving the efficiency of adjusting the image size. In addition, in performing the image inpainting, the pre-trained image inpainting model is first used for the inpainting, and then the large language model is used for further inpainting, which improves the image quality. Furthermore, the electronic device may determine, according to the user's operation, a custom image size as the image size to which the original image is desired to be adjusted, and may determine, according to the user's operation, the direction in which the original image is desired to be expanded, the position and size of the original image in the target image, and the like, so that the final target image can better meet the user's requirements.

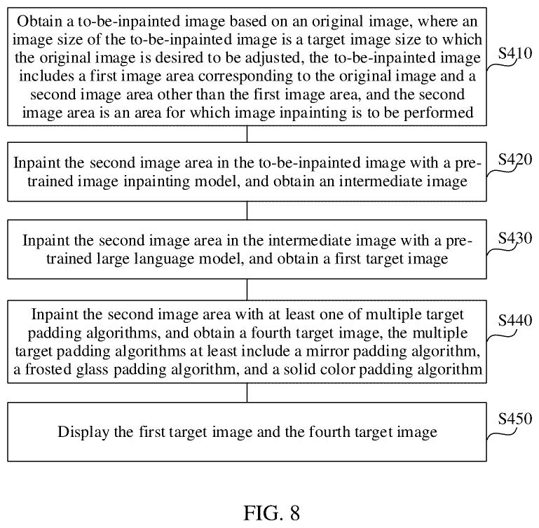

As illustrated in FIG. 8, a flowchart of an image processing method provided in yet a further embodiment of the present disclosure. The image processing method is applied to the above electronic device. The following describes in detail the process shown in FIG. 8. The image processing method may specifically include operations S410 to S450 as follows.

At S410, a to-be-inpainted image is obtained based on an original image, where an image size of the to-be-inpainted image is a target image size to which the original image is desired to be adjusted, the to-be-inpainted image includes a first image area corresponding to the original image and a second image area other than the first image area, and the second image area is an area for which image inpainting is to be performed.

At S420, the second image area in the to-be-inpainted image is inpainted by using a pre-trained image inpainting model, and an intermediate image is obtained therefrom.

At S430, the second image area in the intermediate image is inpainted by using a pre-trained large language model, and a first target image is obtained therefrom.

In the embodiment of the present disclosure, for operations S410 to S430, reference may be made to the contents of the aforementioned embodiment, which will not be repeated here.

At S440, the second image area in the to-be-inpainted image is inpainted by using at least one padding algorithm of multiple target padding algorithms, and a fourth target image is obtained therefrom, where the multiple target padding algorithms at least include a mirror padding algorithm, a frosted glass padding algorithm, and a solid color padding algorithm.

In the embodiment of the present disclosure, for the to-be-inpainted image, the second image area in the to-be-inpainted image may also be inpainted by at least one padding algorithm selected from a mirror padding algorithm, a frosted glass padding algorithm and a solid color padding algorithm, and a fourth target image is thus obtained.

The mirror padding algorithm completes the edge by mirroring the edge pixels of the image. Specifically, for an edge pixel position (i, j), the algorithm calculates its offset relative to the edge of the image, and then determines how to fill the pixel value based on whether the offset is positive or negative. If the offset is positive, the algorithm would perform the filling by calculating the pixel value of (i−offset, j−offset). If the offset is negative, the algorithm would perform the filling by calculating the pixel value of (i+offset, j+offset). By continuously iterating the above process, the algorithm may fill the entire second image area in the to-be-inpainted image. The frosted glass padding algorithm is to fill the second image area with frosted glass-shaped image content, and the solid color padding algorithm is to fill the second image area with solid color image content, for example, white or green image content.

At S450, the first target image and the fourth target image are displayed.

In the embodiments of the present disclosure, after the first target image and the fourth target image are obtained, the first target image and the fourth target image may be displayed. For example, the first target image and the fourth target image are displayed in a preview interface configured to present the image size adjustment result, so that the user can conveniently view the final results after the image size adjustment, and select, based on the displayed results, a corresponding image as the required result.

In some embodiments, the electronic device may detect an operation performed on the preview interface. Upon detecting a selection operation for the first target image or the fourth target image, the electronic device may store the image selected by the selection operation.

In some embodiments, after obtaining the first target image and the fourth target image, the electronic device may also score the image quality of the first target image and the image quality of the fourth target image with a pre-trained image quality assessment model, and obtain a first score of the first target image and a second score of the fourth target image. When displaying the first target image and the fourth target image, the electronic device may display the first target image and its first score together, and display the fourth target image and its second score together, so as to provide a reference for image selection by the user.

The image quality assessment model may be pre-trained, and the training of the image quality assessment model may include: acquiring sample images and scores annotated for the sample images, and then using the sample images and their annotated scores to train the initial model. That is, the initial model is trained by taking the sample images as input and taking the scores as output, thereby obtaining the image quality assessment model. The initial model may be a convolutional neural network, or it may be composed of an image feature extraction model and a classifier, and the specific model thereof is not limited here.

In a possible implementation, the score annotated for a sample image may include scores from different users. Specifically, the electronic device may acquire scores of a sample image from multiple users, and thus obtain multiple user scores. Then, the electronic device nay calculate the mean and variance of the multiple user scores, and calculate a difference between the mean and the variance. When the difference is greater than a preset difference, the electronic device may determine the highest score and the lowest score among the multiple user scores, use scores of the multiple user scores expect the highest and lowest scores as target user scores, calculate the mean of the multiple target user scores, and determine the mean of the multiple target user scores as the score of the sample image. When the difference is not greater than the preset difference, the electronic device may determine the mean of the multiple user scores as the score of the sample image. By determining the score of the sample image in this manner, the evaluation information of different users may be considered, thereby improving the accuracy of the label data of the sample image.

In some embodiments, after obtaining the first target image and fourth target image, the electronic device may also score the image quality of the first target image and the image quality of the fourth target image with the pre-trained image quality assessment model, and obtain a first score of the first target image and a second score of the fourth target image. Then, the electronic device may compare the first score with the second score. According to the comparison result, if the first score is higher than the second score, the first target image is displayed as the image size adjustment result; if the second score is higher than the first score, the second target image is displayed as the image size adjustment result; and if the second score is equal to the first score, both the first target image and the second target image are displayed as the image size adjustment results.

With the image processing method provided in the embodiment of the present disclosure, in adjusting the image size of the original image, the area other than the original image in the to-be-inpainted image (which is obtained based on the original image) may be inpainted, which eliminates the need for the user to perform padding or expansion on the basis of the original image by himself/herself, thereby improving the efficiency of adjusting the image size. In addition, when performing the image inpainting, the pre-trained image inpainting model is first used for the inpainting, and then the large language model is used for further inpainting, which improves the image quality. Furthermore, the second image area in the to-be-inpainted image is inpainted using at least one padding algorithm selected from the mirror padding algorithm, the frosted glass padding algorithm, and the solid color padding algorithm, thereby obtaining an image inpainted in another manner, which provides the user with more choices.

As illustrated in FIG. 9, a structural block diagram of an image processing apparatus 500 provided in an embodiment of the present disclosure is shown. The image processing apparatus 500 is applied to the above electronic device. The image processing apparatus 500 includes: an image acquisition module 510, a first inpainting module 520 and a second inpainting module 530. The image acquisition module 510 is configured to obtain a to-be-inpainted image based on an original image, an image size of the to-be-inpainted image is a target image size to which the original image is desired to be adjusted, the to-be-inpainted image includes a first image area corresponding to the original image and a second image area other than the first image area, and the second image area is an area for which image inpainting is to be performed. The first inpainting module 520 is configured to inpaint the second image area in the to-be-inpainted image with a pre-trained image inpainting model, and obtain an intermediate image therefrom. The second inpainting module 530 is configured to inpaint the second image area in the intermediate image with a pre-trained large language model, and obtain a first target image therefrom.

In some embodiments, the second inpainting module 530 may be specifically configured to: acquire an input target prompt word, where the target prompt word represents information on target inpainting of the second image area; and input the target prompt word and the intermediate image into the pre-trained large language model, and obtain the first target image in which the second image area has been inpainted by the large language model.

In some embodiments, the first inpainting module 520 may be specifically configured to: acquire an inpainting mask image corresponding to the to-be-inpainted image; and input the to-be-inpainted image and the inpainting mask image into the pre-trained image inpainting model, and obtain the intermediate image in which the second image area has been inpainted by the image inpainting model.

In some embodiments, the image acquisition module 510 may be specifically configured to: acquire the target image size to which the original image is desired to be adjusted, where the target image size is any one of a plurality of preset image sizes; and when the target image size is larger than the image size of the original image and a first aspect ratio of the original image does not match a second aspect ratio of the target image size, acquire the to-be-inpainted image based on the target image size and the original image. The first aspect ratio is a ratio of the length to the width of the original image, and the second aspect ratio is a ratio of the length to the width of the target image size.

In a possible implementation, the image acquisition module 510 may be specifically configured to: when the target image size is larger than the image size of the original image and the first aspect ratio does not match the second aspect ratio, generate the to-be-inpainted image based on the target image size with the original image as a center, where the second image area in the to-be-inpainted image is a blank area.

In a possible implementation, the image processing apparatus 500 may further include an image scaling module. The image scaling module may be configured to, after the target image size to which the original image is desired to be adjusted is acquired, when the first aspect ratio matches the second aspect ratio, downscale or upscale the original image according to the target image size while keeping the first aspect ratio of the original image unchanged, and obtain a second target image of the target image size.

In a possible implementation, the image processing apparatus 500 may further include an image cropping module. The image cropping module may be configured to, after the target image size to which the original image is desired to be adjusted is acquired, when the target image size is smaller than the image size of the original image and the first aspect ratio is different from the second aspect ratio, crop the original image according to the target image size, and obtain a third target image of the target image size.

In some embodiments, the image acquisition module 510 may be specifically configured to: acquire the target image size to which the original image is desired to be adjusted, where the target image size is a custom image size; and obtain the to-be-inpainted image based on the target image size and the original image.

In a possible implementation, the image acquisition module 510 may be specifically configured to: display a preview interface based on the target image size, where the preview interface includes a preview area, the size of the preview area is equal to the target image size, and the preview area includes the first image area; in response to a first adjustment operation performed on the first image area, adjust the position of the first image area in the preview area, and/or adjust the size of the first image area; and in response to a first confirmation operation performed on the preview area, generate the to-be-inpainted image based on the preview area.

In a possible implementation, the image acquisition module 510 may further be configured to display a preview interface, where the preview interface includes a preview area, and the preview area includes the first image area; in response to a second adjustment operation performed on the preview area, adjust the position of at least one edge of the preview area relative to the edge of the first image area; in response to a second confirmation operation performed on the preview area, acquire the current size of the preview area as the target image size to which the original image is desired to be adjusted.

In some implementations, the image processing apparatus 500 may further include a third inpainting module and a result display module. The third inpainting module is configured to, after the to-be-inpainted image is obtained based on the original image, inpaint the second image area by using at least one padding algorithm of multiple target padding algorithms, and obtain a fourth target image therefrom. The multiple target padding algorithms at least include a mirror padding algorithm, a frosted glass padding algorithm and a solid color padding algorithm. The result display module is configured to, after the first target image is obtained by inpainting the second image area in the intermediate image with the pre-trained large language model, display the first target image and the fourth target image.

Those skilled in the art can clearly understand that, for the convenience and brevity of description, the specific working processes of the above apparatus and modules may refer to the corresponding processes in the aforementioned method embodiments, which will not be repeated here.

In the embodiments of the present disclosure, the coupling between modules may be electrical, mechanical or in other forms.

In addition, the individual functional modules in each embodiment of the present disclosure may be integrated into one processing module, or each module may exist physically separately, or two or more modules may be integrated into one module. The integrated module may be implemented in the form of hardware or software functional modules.

In summary, with the solutions provided by the present disclosure, a to-be-inpainted image is obtained based on an original image, where the image size of the to-be-inpainted image is the target image size to which the original image is desired to be adjusted, the to-be-inpainted image includes a first image area corresponding to the original image and a second image area other than the first image area, and the second image area is an area for which image inpainting is to be performed. The second image area in the to-be-inpainted image is inpainted with a pre-trained image inpainting model, and an intermediate image is obtained therefrom. The second image area in the intermediate image is inpainted with a pre-trained large language model, and a first target image is obtained therefrom. In this way, in adjusting the image size of the original image, the area other than the original image in the to-be-inpainted image (which is obtained based on the original image) is inpainted, which eliminates the need for the user to perform padding or augmentation on the basis of the original image by himself/herself, thereby improving the efficiency of adjusting the image size. In addition, when performing the image inpainting, the pre-trained image inpainting model is first used for the inpainting, and then the large language model is used for further inpainting, which improves the image quality.

As illustrated in FIG. 10, a structural block diagram of an electronic device provided in an embodiment of the present disclosure is shown. The electronic device 100 may be a smart phone, a tablet computer, a laptop computer, an e-book, or other electronic device capable of running application programs. The electronic device 100 in the present disclosure may include one or more of: a processor 110, a memory 120, and one or more application programs. The one or more application programs may be stored in the memory 120 and configured to be executed by one or more processors 110, and the one or more application programs are configured to execute the method described in the aforementioned method embodiments.

The processor 110 may include one or more processing cores. The processor 110 uses various interfaces and lines to connect various parts within the entire electronic device 100, and performs various functions of the electronic device 100 and processes data by running or executing instructions, programs, code sets or instruction sets stored in the memory 120, and calling data stored in the memory 120. Optionally, the processor 110 may be implemented in at least one of digital signal processing (DSP), field-programmable gate array (FPGA), and programmable logic array (PLA). The processor 110 may integrate one or a combination of a central processing unit (CPU), a graphics processing unit (GPU), a modem, and the like. The CPU mainly processes the operating system, user interface, and application programs. The GPU is responsible for rendering and drawing of display content. The modem is used to handle wireless communications. It is understandable that the modem may not be integrated into the processor 110, and may be implemented separately through a communication chip.

The memory 120 may include a random access memory (RAM) and a read-only memory (ROM). The memory 120 may be used to store instructions, programs, codes, code sets, or instruction sets. The memory 120 may include a program storage area and a data storage area. The program storage area may store instructions for implementing an operating system, instructions for implementing at least one function (such as a touch function, a sound playback function, and an image playback function), instructions for implementing the method embodiments, etc. The data storage area may also store data created by the electronic device 100 during use (such as a phone book, audio and video data, and chat record data).

As illustrated in FIG. 11, a block diagram of a computer-readable storage medium provided in an embodiment of the present disclosure is shown. The computer-readable medium 800 stores therein program codes which can be called by a processor to execute the method described in the above method embodiments.

The computer-readable storage medium 800 may be an electronic memory such as a flash memory, an Electrically Erasable Programmable Read Only Memory (EEPROM), an EPROM, a hard disk, or a ROM. Optionally, the computer-readable storage medium 800 includes a non-transitory computer-readable storage medium. The computer-readable storage medium 800 has a storage space for program codes 810 for executing any method steps in the above-described methods. The program codes may be read from or written into one or more computer program products. The program codes 810 may be compressed, for example, in a suitable form.

Finally, it is notable that the above embodiments are only used to illustrate the technical solutions of the present disclosure, rather than to limit it. Although the present disclosure has been described in detail with reference to the aforementioned embodiments, those skilled in the art should understand that they can still modify the technical solutions described in the aforementioned embodiments, or make equivalent replacements for some of the technical features therein. However, these modifications or replacements do not cause the essence of the corresponding technical solutions to deviate from the spirit and scope of the technical solutions of the embodiments of the present disclosure.

What is claimed is:

1. An image processing method, comprising:
obtaining a to-be-inpainted image based on an original image, wherein an image size of the to-be-inpainted image is a target image size to which the original image is desired to be adjusted, the to-be-inpainted image comprises a first image area corresponding to the original image and a second image area other than the first image area, and the second image area is an area for which image inpainting is to be performed;
inpainting, with a pre-trained image inpainting model, the second image area in the to-be-inpainted image, and obtaining an intermediate image in which the second image area has been inpainted by the image inpainting model; and
inpainting, with a pre-trained large language model, the second image area in the intermediate image, and obtaining a first target image in which the second image area has been inpainted by the large language model.

2. The method as claimed in claim 1, wherein inpainting, with the pre-trained large language model, the second image area in the intermediate image and obtaining the first target image in which the second image area has been inpainted by the large language model, comprises:
acquiring a target prompt word, wherein the target prompt word represents information on target inpainting of the second image area; and
inputting the target prompt word and the intermediate image into the pre-trained large language model, and obtaining, from the large language model, the first target image in which the second image area has been inpainted by the large language model.

3. The method according to claim 1, wherein inpainting, with the pre-trained image inpainting model, the second image area in the to-be-inpainted image and obtaining the intermediate image in which the second image area has been inpainted by the image inpainting model, comprises:
acquiring an inpainting mask image corresponding to the to-be-inpainted image; and
inputting the to-be-inpainted image and the inpainting mask image into the pre-trained image inpainting model, and obtaining, from the image inpainting model, the intermediate image in which the second image area has been inpainted by the image inpainting model.

4. The method as claimed in claim 1, wherein obtaining the to-be-inpainted image based on the original image comprises:
acquiring the target image size to which the original image is desired to be adjusted, wherein the target image size is any one of a plurality of preset image sizes; and
in response to the target image size being larger than an image size of the original image, and a first aspect ratio of the original image not matching a second aspect ratio of the target image size, obtaining the to-be-inpainted image based on the target image size and the original image, wherein the first aspect ratio is a ratio of a length to a width of the original image, and the second aspect ratio is a ratio of a length to a width of the target image size.

5. The method as claimed in claim 4, wherein obtaining the to-be-inpainted image based on the target image size and the original image, comprises:
generating the to-be-inpainted image based on the target image size with the original image as a center, wherein the second image area in the generated to-be-inpainted image is a blank area.

6. The method as claimed in claim 5, wherein generating the to-be-inpainted image based on the target image size with the original image as the center, comprises:
gradually upscaling the original image while keeping the first aspect ratio of the original image unchanged, until an absolute value of a difference between the length of the original image and the length of the target image size is less than a preset length, or until an absolute value of a difference between the width of the original image and the width of the target image size is less than a preset width; and
generating the to-be-inpainted image based on the upscaled original image and the target image size, with the upscaled original image as the center.

7. The method as claimed in claim 4, wherein after acquiring the target image size to which the original image is desired to be adjusted, the method further comprises:
in response to the first aspect ratio matching the second aspect ratio, downscaling or upscaling the original image according to the target image size while keeping the first aspect ratio of the original image unchanged, and obtaining a second target image of the target image size.

8. The method as claimed in claim 4, wherein after acquiring the target image size to which the original image is desired to be adjusted, the method further comprises:
in response to the target image size being smaller than the image size of the original image, and the first aspect ratio being different from the second aspect ratio, cropping the original image according to the target image size, and obtaining a third target image of the target image size.

9. The method as claimed in claim 8, wherein cropping the original image according to the target image size, comprises:
gradually downscaling the original image while keeping the first aspect ratio of the original image unchanged, until an absolute value of a difference between the length of the original image and the length of the target image size is less than a preset length, or until an absolute value of a difference between the width of the original image and the width of the target image size is less than a preset width; and
determining a target image area of the target image size based on a center position of the downscaled original image, and cropping out remaining areas other than the target image area in the downscaled original image.

10. The method as claimed in claim 1, wherein obtaining the to-be-inpainted image based on the original image comprises:
acquiring the target image size to which the original image is desired to be adjusted, wherein the target image size is a custom image size; and
obtaining the to-be-inpainted image, based on the target image size and the original image.

11. The method as claimed in claim 10, wherein obtaining the to-be-inpainted image based on the target image size and the original image comprises:
displaying a preview interface based on the target image size, wherein the preview interface comprises a preview area, a size of the preview area is equal to the target image size, and the preview area comprises the first image area;
in response to a first adjustment operation performed on the first image area, adjusting a position of the first image area in the preview area, and/or adjusting a size of the first image area; and
in response to a first confirmation operation performed on the preview area, generating the to-be-inpainted image based on the preview area.

12. The method as claimed in claim 10, wherein acquiring the target image size to which the original image is desired to be adjusted comprises:
displaying a preview interface, wherein the preview interface comprises a preview area, and the preview area comprises the first image area;
in response to a second adjustment operation performed on the preview area, adjusting a position of at least one edge of the preview area relative to an edge of the first image area; and
in response to a second confirmation operation performed on the preview area, acquiring a current size of the preview area as the target image size to which the original image is desired to be adjusted.

13. The method as claimed in claim 1, wherein after obtaining the to-be-inpainted image based on the original image, the method further comprises:
inpainting the second image area with at least one padding algorithm of a plurality of target padding algorithms, and obtaining a fourth target image in which the second image area has been inpainted by the at least one padding algorithm, wherein the plurality of target padding algorithms at least comprise a mirror padding algorithm, a frosted glass padding algorithm, and a solid color padding algorithm; and
after inpainting, with the pre-trained large language model, the second image area in the intermediate image and obtaining the first target image, the method further includes:
displaying the first target image and the fourth target image.

14. The method as claimed in claim 13, wherein displaying the first target image and the fourth target image comprises:
scoring, with a pre-trained image quality assessment model, image quality of the first target image and image quality of the fourth target image, and obtaining a first score of the image quality of the first target image and a second score of the image quality of the fourth target image;
in response to the first score being higher than the second score, displaying the first target image as an image size adjustment result;
in response to the second score being higher than the first score, displaying the second target image as the image size adjustment result;
in response to the second score being equal to the first score, displaying both the first target image and the second target image as the image size adjustment results.

15. An electronic device, comprising:
one or more processors;
a memory; and
one or more programs, wherein the one or more programs are stored in the memory, and the one or more programs, when being executed by the one or more processors, cause the one or more processors to:
obtain a to-be-inpainted image based on an original image, wherein the to-be-inpainted image has an image size the same as a target image size to which the original image is desired to be adjusted, the to-be-inpainted image comprises a first image area corresponding to the original image and a second image area other than the first image area, and the second image area is an area for which image inpainting is to be performed;
inpaint, with an image inpainting model, the second image area in the to-be-inpainted image, and obtain an intermediate image in which the second image area has been inpainted by the image inpainting model; and
inpaint, with a large language model, the second image area in the intermediate image, and obtain a first target image in which the second image area has been inpainted by the large language model.

16. The electronic device as claimed in claim 15, wherein the one or more programs, when being executed by the one or more processors, further cause the one or more processors to:
inpaint, with the image inpainting model, the second image area in the to-be-inpainted image, based on an inpainting mask image corresponding to the to-be-inpainted image; and
inpaint, with the large language model, the second image area in the intermediate image based on a target prompt word, wherein the target prompt word represents information on target inpainting of the second image area.

17. The electronic device as claimed in claim 15, wherein the one or more programs, when being executed by the one or more processors, further cause the one or more processors to:
acquire the target image size to which the original image is desired to be adjusted, wherein the target image size is any one of a plurality of preset image sizes; and
in response to the target image size being larger than an image size of the original image, and a first aspect ratio of the original image not matching a second aspect ratio of the target image size, generate the to-be-inpainted image based on the target image size with the original image as a center, wherein the first aspect ratio is a ratio of a length to a width of the original image, the second aspect ratio is a ratio of a length to a width of the target image size, and the second image area in the generated to-be-inpainted image is a blank area.

18. The electronic device as claimed in claim 17, wherein the one or more programs, when being executed by the one or more processors, further cause the one or more processors to:
in response to the first aspect ratio matching the second aspect ratio, downscale or upscale the original image according to the target image size while keeping the first aspect ratio of the original image unchanged, and obtain a second target image of the target image size;
in response to the target image size being smaller than the image size of the original image, and the first aspect ratio being different from the second aspect ratio, crop the original image according to the target image size, and obtain a third target image of the target image size.

19. The electronic device as claimed in claim 15, wherein the target image size is a custom image size, and the one or more programs, when being executed by the one or more processors, further cause the one or more processors to:
display a preview interface, wherein the preview interface comprises a preview area, and the preview area comprises the first image area;
in response to an adjustment operation performed on the preview area, adjust a position of at least one edge of the preview area relative to an edge of the first image area; and
in response to a confirmation operation performed on the preview area, acquire a current size of the preview area as the target image size to which the original image is desired to be adjusted.

20. A non-transitory computer-readable storage medium storing program codes therein, wherein the program codes, when being executed by a processor, cause the processor to implement an image processing method comprising:
obtaining a to-be-inpainted image based on an original image, wherein the to-be-inpainted image has an image size the same as a target image size to which the original image is desired to be adjusted, the to-be-inpainted image comprises a first image area corresponding to the original image and a second image area other than the first image area, and the second image area is an area for which image inpainting is to be performed;
inpainting, with an image inpainting model, the second image area in the to-be-inpainted image, and obtaining an intermediate image in which the second image area has been inpainted by the image inpainting model; and
inpainting, with a large language model, the second image area in the intermediate image, and obtaining a first target image in which the second image area has been inpainted by the large language model.
